(19) United States
(12) Patent Application Publication
(10) Pub. No.: US 2025/0016747 A1
(43) Pub. Date: Jan. 9, 2025

(54) CHANNEL STATE INFORMATION TRANSMITTING METHOD AND APPARATUS, AND REFERENCE SIGNAL TRANSMITTING METHOD AND APPARATUS

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/710,975

(22) PCT Filed: Nov. 30, 2021
(86) PCT No.: PCT/CN2021/134666

§ 371 Date: May 16, 2024

(51) Int. Cl. H04W 72/0446; H04L 5/00

(52) U.S. Cl. CPC H04W 72/0446; H04L 5/0035; H04L 5/0051; H04L 5/0096

(57) ABSTRACT

A method and apparatus for transmitting channel state information (CSI) and reference signals to improve utilization of a wireless network. The utilization of the wireless network is improved by: determining a time domain resource range of a secondary cell activation specific channel state information reference signal (SAS-CSI RS); receiving the SAS-CSI RS according to the time domain resource range; and generating valid CSI according to the SAS-CSI RS and transmitting the valid CSI to a network side device.

### CROSS-REFERENCE TO RELATED APPLICATIONS

The present application is a U.S. National Stage of International Application No. PCT/CN2021/134666, filed on Nov. 30, 2021, the contents of all of which are incorporated herein by reference in their entirety for all purposes.

### BACKGROUND OF THE INVENTION

In a radio communication network, a network side can configure a terminal with a plurality of serving cells. The serving cells can include a primary cell (PCell), a primary secondary cell (PSCell), and other serving cells (also referred to as secondary cells (SCells)).

### SUMMARY OF THE INVENTION

A method and apparatus for transmitting channel state information, a method and apparatus for transmitting a reference signal, a communication apparatus, and a computer-readable storage medium are provided as examples of the disclosure.

In a first aspect, a method for transmitting channel state information is provided according to the example of the disclosure. The method is performed by a terminal and includes: determining a time domain resource range of a secondary cell activation specific channel state information reference signal (SAS-CSI RS); receiving the SAS-CSI RS according to the time domain resource range; and generating valid channel state information (CSI) according to the SAS-CSI RS and transmitting the valid CSI to a network side device.

In a second aspect, a method for transmitting a reference signal is provided according to the example of the disclosure. The method is performed by a network side device and includes: determining a time domain resource range of a secondary cell activation specific channel state information reference signal (SAS-CSI RS); and transmitting the SAS-CSI RS according to the time domain resource range.

In a third aspect, an apparatus for transmitting channel state information is provided according to the example of the disclosure. The apparatus includes one or more processors; where the processor is configured to: determine a time domain resource range of a secondary cell activation specific channel state information reference signal (SAS-CSI RS); receive the SAS-CSI RS according to the time domain resource range; and generate valid channel state information (CSI) according to the SAS-CSI RS and transmit the valid CSI to a network side device.

In a fourth aspect, an apparatus for transmitting a reference signal is provided according to the example of the disclosure. The apparatus includes one or more processors; where the processor is configured to: determine a time domain resource range of a secondary cell activation specific channel state information reference signal (SAS-CSI RS); and transmit the SAS-CSI RS according to the time domain resource range.

In a fifth aspect, a communication apparatus is provided according to the example of the disclosure. The communication apparatus includes: a processor; and a memory configured to store a computer program; where when the computer program is executed by the processor, the above method for transmitting channel state information is implemented.

In a sixth aspect, a communication apparatus is provided according to the example of the disclosure. The communication apparatus includes: a processor; and a memory configured to store a computer program; where when the computer program is executed by the processor, the above method for transmitting a reference signal is implemented.

In a seventh aspect, a computer-readable storage medium is provided according to the example of the disclosure. The computer-readable storage medium is configured to store a computer program, where when the computer program is executed by the processor, steps of the above method for transmitting channel state information is implemented.

In an eighth aspect, a computer-readable storage medium is provided according to the example of the disclosure. The computer-readable storage medium is configured to store a computer program, where when the computer program is executed by the processor, steps of the above method for transmitting a reference signal is implemented.

### BRIEF DESCRIPTION OF DRAWINGS

In order to describe the technical solutions in examples of the disclosure more clearly, the accompanying drawings required for describing the examples are briefly described below. Obviously, the accompanying drawings in the following description are merely some examples of the disclosure, and those of ordinary skill in the art can also derive other accompanying drawings from these accompanying drawings without creative efforts.

FIG. 1 is a schematic diagram of a process of activating a secondary cell (SCell) according to a related example of the disclosure;

FIG. 2 is a schematic diagram of introducing a temporary reference signal in a process of activating an SCell according to a related example of the disclosure;

FIG. 3 is a schematic flowchart of a method for transmitting channel state information shown according to an example of the disclosure;

FIG. 4A is a schematic flowchart of another method for transmitting channel state information shown according to an example of the disclosure;

FIG. 4B is a schematic diagram of a secondary cell activation specific channel state information reference signal (SAS-CSI RS) shown according to an example of the disclosure;

FIG. 5A is a schematic flowchart of yet another method for transmitting channel state information shown according to an example of the disclosure;

FIG. 5B is a schematic diagram of another SAS-CSI RS shown according to an example of the disclosure;

FIG. 6 is a schematic flowchart of yet another method for transmitting channel state information shown according to an example of the disclosure;

FIG. 7 is a schematic flowchart of still another method for transmitting channel state information shown according to an example of the disclosure;

FIG. 8 is a schematic flowchart of a method for transmitting a reference signal shown according to an example of the disclosure;

FIG. 9 is a schematic flowchart of another method for transmitting a reference signal shown according to an example of the disclosure;

FIG. 10 is a schematic flowchart of yet another method for transmitting a reference signal shown according to an example of the disclosure;

FIG. 11 is a schematic flowchart of still another method for transmitting a reference signal shown according to an example of the disclosure;

FIG. 12 is a schematic block diagram of an apparatus for transmitting a reference signal shown according to an example of the disclosure; and

FIG. 13 is a schematic block diagram of an apparatus for transmitting channel state information shown according to an example of the disclosure.

### DETAILED DESCRIPTION OF THE INVENTION

The technical solutions in examples of the disclosure are clearly and completely described below with reference to the accompanying drawings in the examples of the disclosure. Apparently, the examples described are merely some examples rather than all examples of the disclosure. Based on the examples of the disclosure, all other examples derived by those of ordinary skill in the art without creative efforts fall within the scope of protection of the disclosure.

The terms used in the examples of the disclosure are merely used to describe specific examples, rather than limit the examples of the disclosure. The singular forms such as “a/an”, and “the” used in the examples of the disclosure and the appended claims are also intended to include the plural forms, unless clearly stated in the context otherwise. It should also be understood that the term “and/or” used here means and encompasses one or any or all possible combinations of a plurality of associated items listed.

It should be understood that although the terms first, second, third, etc., may be employed in the examples of the disclosure to describe various information, such information should not be limited to this. These terms are merely used to distinguish between the same type of information. For example, first information can also be referred to as second information, and similarly, second information can also be referred to as first information, without departing from the scope of the examples of the disclosure. The word “if,” as used herein, can be interpreted as “at the time of,” “when,” or “in response to determining,” depending on the context.

For the purposes of brevity and easy understanding, the terms “greater than,” “less than,” “higher than,” or “lower than” are used here to denote a magnitude relation. However, those skilled in the art can understand that the term “greater than” also covers the meaning of “greater than or equal to,” and the term “less than” also covers the meaning of “less than or equal to”; and the term “higher than” covers the meaning of “higher than or equal to,” and the term “lower than” also covers the meaning of “lower than or equal to.”

In the related art, a temporary reference signal (temporary RS) is introduced to accelerate an activation/deactivation process of the SCell. However, the activation/deactivation process of the SCell can only be accelerated partially based on the temporary RS, leading to an undesirable effect of accelerating activation/deactivation of the SCell.

The disclosure relates to the technical field of communication, and in particular to a method and apparatus for transmitting channel state information, a method and apparatus for transmitting a reference signal, a communication apparatus, and a computer-readable storage medium.

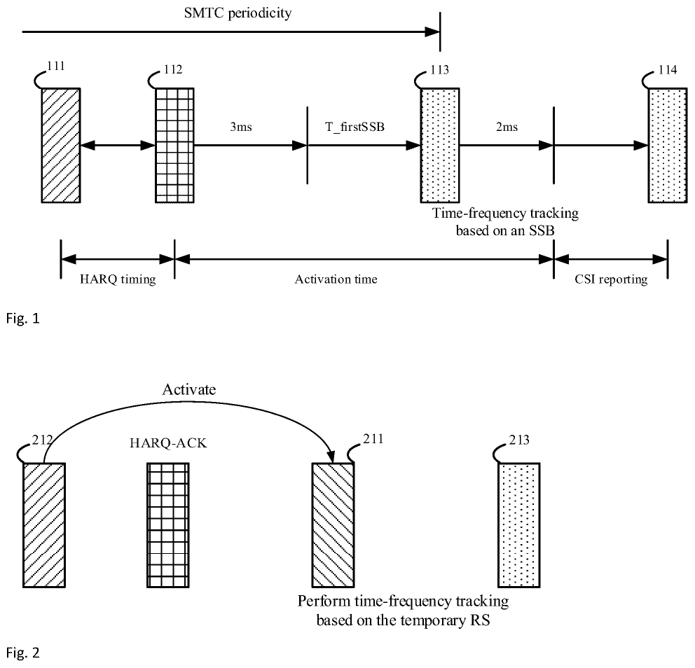

FIG. 1 is a schematic diagram of a process of activating a secondary cell (SCell) according to a related example of the disclosure.

As shown in FIG. 1, the process of activating the SCell in a deactivated state primarily includes three steps:

A network side carries an activation indication in a media access control control element (MAC CE) that is to be transmitted to a terminal. For example, the MAC CE 111 is carried in a physical downlink shared channel (PDSCH) of a primary cell (PCell). After receiving the MAC CE 111, the terminal indicates to the network side that the terminal has received the MAC CE 111 by returning hybrid automatic repeat request (HARQ) information, for example, HARQ-acknowledgement (ACK) 112, to a network side device. This stage is referred to as HARQ timing.

Next, after receiving the MAC CE 111, the terminal prepares hardware, which may further include a plurality of sub-steps: first, specific information carried in the MAC CE 111 is determined by parsing the MAC CE 111. For example, 3 ms is determined to be consumed. Then, the terminal waits to receive a synchronization signal block (SSB) 113, for example, the terminal keeps waiting for duration T_firstSSB. After receiving the SSB 113, the terminal performs SSB-based time-frequency tracking. This stage is referred to as activation time.

Finally, the terminal generates valid channel state information (CSI) 114 according to a channel state information reference signal (CSI RS, generally referred to as a P-CSI-RS) continuously transmitted by the network side and configured to activate the SCell and reports the valid CSI 114 to the network side. The network side determines activation of the SCell according to the valid CSI. This stage is referred to as CSI reporting.

In the process, the terminal may generate the valid CSI 114 for reporting according to the P-CSI-RS continuously transmitted by the network side after completing time-frequency tracking first. Since time-frequency tracking is implemented based on the SSB 113, the SSB 113 is required to be received first. However, as shown in FIG. 1, the SSB 113 is received based on SMTC periodicity, i.e. SSB measurement timing configuration periodicity. However, the periodicity is long, which makes it difficult to complete time-frequency tracking in time. To solve the problem, a temporary reference signal (RS) is further provided in the related art.

FIG. 2 is a schematic diagram of introducing a temporary reference signal in a process of activating an SCell according to a related example of the disclosure.

As shown in FIG. 2, the network side may periodically transmit the temporary RS 211, where temporary RS periodicity is shorter than the SMTC periodicity. The terminal may be activated to receive the temporary RS 211 through the MAC CE 212. Since the temporary RS periodicity is short, the terminal may receive the temporary RS 211 more rapidly relative to the SSB after receiving the MAC CE 212, and perform an automatic gain control (AGC) setting and time-frequency (T/F) tracking according to the temporary RS 211. Thus, time-frequency tracking is completed more rapidly relative to the case in FIG. 1, and valid CSI 213 reporting is completed more rapidly, so that the process of activating the SCell is accelerated.

It can be seen from FIG. 2 that the process of activating the SCell may be accelerated by introducing the temporary RS 211. However, it can be seen from the analysis that the process of activating the SCell is only partially accelerated. Specifically, a stage of completing time-frequency tracking in the process of activating the SCell is accelerated. Since the terminal generates the valid CSI 213 for reporting according to the P-CSI-RS continuously transmitted by the network side, with the temporary RS 211 introduced, the stage from completing time-frequency tracking to valid CSI 213 reporting is not accelerated.

In order to accelerate valid CSI reporting, one of the main ways is to shorten periodicity of the P-CSI-RS, so that the terminal may generate the valid CSI for reporting according to the P-CSI-RS. At present, minimum periodicity of the P-CSI-RS involves 4 slots, and maximum periodicity involves 640 slots. Since the P-CSI-RS is continuously transmitted by the network side, the network overhead will be dramatically increased by shortening the periodicity of the P-CSI-RS. In view of the technical problem, the example of the disclosure is provided.

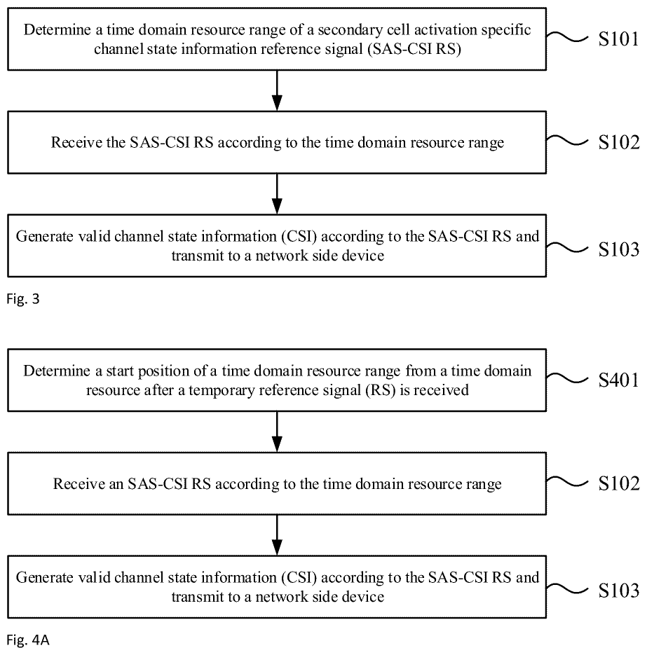

FIG. 3 is a schematic flowchart of a method for transmitting channel state information shown according to an example of the disclosure. The method for transmitting channel state information shown in the example may be performed by the terminal. The terminal includes, but is not limited to, a mobile phone, a tablet computer, a wearable device, a sensor, an Internet of Things device, etc. The terminal may communicate with the network side device. The network side device includes, but is not limited to, a network side device in a 4th generation (4G) communication system, a fifth generation (5G) communication system, a sixth generation (6G) communication system, etc., and may be, for example, a base station or a core network.

As shown in FIG. 3, the method for transmitting channel state information may include:

S101, a time domain resource range of a secondary cell activation specific channel state information reference signal (SAS-CSI RS) is determined;

S102, the SAS-CSI RS is received according to the time domain resource range; and

S103, valid channel state information (CSI) is generated according to the SAS-CSI RS and transmitted to the network side device.

In an example, the network side device may transmit (via broadcast, unicast, or groupcast) the secondary cell activation specific channel state information reference signal, which may be fully referred to as Scell activation specific CSI RS and is referred to as SAS-CSI RS below for the convenience of description.

The network side device and the terminal may determine the time domain resource range (for example, a time window) of the SAS-CSI RS separately. The network side device may transmit the SAS-CSI RS within the time domain resource range determined or transmit the SAS-CSI RS within the time domain resource range determined according to configuration information configured for the terminal.

The configuration information may include periodicity, a number of periodicity (which may be interpreted as a number of transmission), etc. of the SAS-CSI RS. For example, the periodicity involves N slots, where N is smaller than a periodicity threshold M, and M may be set as required. For example, M=10. Generally, a minimum value of N is 4, and the terminal may receive the SAS-CSI RS as soon as possible by appropriately setting the value of N to be small.

The terminal may receive the SAS-CSI RS within the time domain resource range determined. For example, the SAS-CSI RS is transmitted within the time domain resource range determined according to the configuration information configured by the network side device. After receiving the SAS-CSI RS, the terminal may generate the valid CSI according to the SAS-CSI RS and transmit the valid CSI to the network side device. The network side device may determine whether the SCell is activated according to the valid CSI.

According to the example of the disclosure, the network side device transmits the secondary cell activation specific channel state information reference signal (SAS-CSI RS) only within the time domain resource range instead of continuously transmitting the SAS-CSI RS. Correspondingly, the terminal is required to receive the SAS-CSI RS only within the time domain resource range.

Accordingly, even if periodicity of the SAS-CSI RS is set to be short, since the network side device transmits the SAS-CSI RS only within the time domain resource range and transmits no SAS-CSI RS outside the time domain resource range, the impact on overhead of the network side device is small. Correspondingly, the terminal receives the SAS-CSI RS only within the time domain resource range and receives no SAS-CSI RS outside the time domain resource range. The periodicity of the SAS-CSI RS is shortened without dramatically increasing network overhead, so that the terminal may activate the secondary cell by receiving the SAS-CSI RS and reporting the valid CSI more rapidly.

In an example, the means of determining the time domain resource range include at least one of:
the time domain resource range is determined according to indication information transmitted by the network side device; or
the time domain resource range is determined according to a protocol.

In an example, when the time domain resource range of the SAS-CSI RS may be determined according to the protocol, the network side device and the terminal may determine the time domain resource range of the SAS-CSI RS according to the protocol. The network side device may transmit the SAS-CSI RS within the time domain resource range, and the terminal may receive the SAS-CSI RS within the time domain resource range.

In an example, the time domain resource range of the SAS-CSI RS may be set by the network side device as required and transmitted to the terminal through the indication information, in this case, the network side device may autonomously determine the time domain resource range of the SAS-CSI RS and indicate the time domain resource range to the terminal through the indication information. The network side device may transmit the SAS-CSI RS within the time domain resource range, and the terminal may receive the SAS-CSI RS within the time domain resource range.

The indication information may be carried in the MAC CE, and the MAC CE carrying the indication information may be the same as the MAC CE configured to activate the temporary RS. The indication information may also be carried in other MAC CEs.

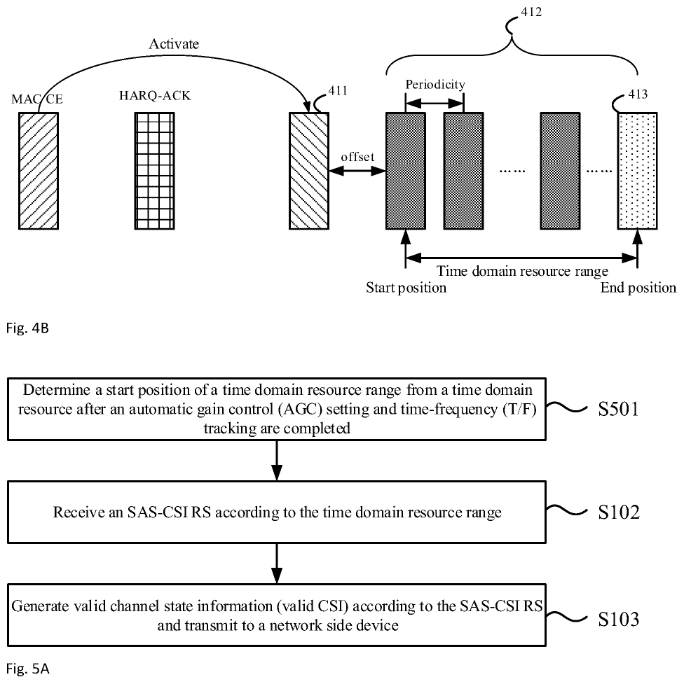

FIG. 4A is a schematic flowchart of another method for transmitting channel state information shown according to an example of the disclosure. As shown in 4A, the time domain resource range of a secondary cell activation specific channel state information reference signal (SAS-CSI RS) is determined includes:

S401, a start position of the time domain resource range is determined from a time domain resource after the temporary reference signal (RS) is received.

In an example, the network side device may determine the start position of the time domain resource range from the time domain resources after the temporary RS is transmitted according to the protocol. Correspondingly, the terminal may determine the start position of the time domain resource range from the time domain resource after the temporary RS is received according to the protocol.

For example, the start position may be determined according to a slot in which the temporary RS is positioned and an offset (greater than or equal to 0 slot). For example, the start position is a position obtained after the offset is added to the slot in which the temporary RS is positioned. The offset may be indicated by the network side device or determined according to the protocol.

In an example, the network side device may set the start position of the time domain resource range from the time domain resource after the temporary RS is transmitted as required, transmit the indication information to the terminal, and instruct the terminal to determine the start position of the time domain resource range from the time domain resource after the temporary RS is received through the indication information.

For example, the start position may be determined according to the slot in which the temporary RS is positioned and the offset. For example, the start position is the position obtained after the offset is added to the slot in which the temporary RS is positioned. The offset may be determined according to the protocol or indicated by the network side device.

In an example, since the network side device determines that the valid CSI is required to be reported as soon as possible when configuring the terminal with the temporary RS and activating the terminal to receive the temporary RS, the start position of the time domain resource range may be determined from the time domain resource after the temporary RS is received. Thus, the terminal starts receiving the SAS-CSI RS from the start position when the temporary RS is received and the valid CSI is determined to be reported as soon as possible. Correspondingly, the network side device may start transmitting the SAS-CSI RS after transmitting the temporary RS. The resource waste caused when the terminal receives the SAS-CSI RS and the network side device transmits the SAS-CSI RS in a case that no valid CSI is required to be reported as soon as possible can be avoided.

FIG. 4B is a schematic diagram of an SAS-CSI RS shown according to an example of the disclosure.

As shown in FIG. 4B, the start position of the time domain resource range is the position obtained after the offset is added to the slot in which the temporary RS 411 is positioned. The network side device periodically transmits the SAS-CSI RS 412, periodicity may be configured as required, and an end position of the time domain resource range may be, for example, a time domain position where valid CSI 413 reporting is completed. When the offset is 0, the start position may be a first slot after the slot in which the temporary RS 411 is positioned.

FIG. 5A is a schematic flowchart of yet another method for transmitting channel state information shown according to an example of the disclosure. As shown in 5A, the time domain resource range of a secondary cell activation specific channel state information reference signal (SAS-CSI RS) is determined includes:

S501, a start position of the time domain resource range is determined from a time domain resource after an automatic gain control (AGC) setting and time-frequency (T/F) tracking are completed.

In an example, the terminal may determine the start position of the time domain resource range from the time domain resource after the AGC setting and T/F tracking are completed according to the protocol. Alternatively, the terminal may determine the start position of the time domain resource range from the time domain resource after the AGC setting and T/F tracking are completed according to an indication from the network side device.

In this case, the terminal may determine the start position of the time domain resource range from the time domain resource after the AGC setting and T/F tracking are completed, and start receiving the SAS-CSI RS at the start position. Since the AGC setting and T/F tracking are performed by the terminal, the network side device is not necessarily capable of determining when the terminal completes the AGC setting and T/F tracking.

If it is impossible for the network side device to determine when the terminal completes the AGC setting and T/F tracking, in order to ensure that the terminal may receive the SAS-CSI RS after completing the AGC setting and T/F tracking, the start position configured to transmit the SAS-CSI RS and determined by the network side device may precede the start position configured to receive the SAS-CSI RS and determined by the terminal.

For example, the start position configured to transmit the SAS-CSI RS and determined by the network side device may be the first slot after the temporary RS is transmitted or a slot before the temporary RS is transmitted. Since the terminal is required to perform the AGC setting and T/F tracking according to the temporary RS, in order to ensure that the terminal may receive the SAS-CSI RS at the time domain position after the AGC setting and T/F tracking are completed, the network side device starts transmitting the SAS-CSI RS in the first slot after the temporary RS is transmitted or in the slot before the temporary RS is transmitted.

If it is possible for the network side device to determine when the terminal completes the AGC setting and T/F tracking, the network side device may select the first slot after the terminal completes the AGC setting and T/F tracking as the start position for transmitting the SAS-CSI RS, or select the slot before the terminal completes the AGC setting and T/F tracking as the start position for transmitting the SAS-CSI RS. Accordingly, it may be ensured that the terminal may receive the SAS-CSI RS at the time domain position after the AGC setting and T/F tracking are completed.

In an example, before the terminal completes the AGC setting and T/F tracking, the network side may be asynchronous with a terminal side to a certain extent. In consequence, the network side device and the terminal have inconsistent understanding of the time domain resource range, resulting in subsequent problems. In order to avoid such a situation, the terminal may determine the start position of the time domain resource range from the time domain resource after the AGC setting and T/F tracking are completed. Accordingly, it is ensured that the SAS-CSI RS starts being received only after the AGC setting and T/F tracking are completed, and that the SAS-CSI RS is received in a case that the network side device and the terminal have consistent understanding of the time domain resource range.

FIG. 5B is a schematic diagram of another SAS-CSI RS shown according to an example of the disclosure.

As shown in FIG. 5B, for example, the network side device still takes the position obtained after the offset is added to the slot in which the temporary RS 511 is positioned as the start position, i.e., a transmission start position, and starts transmitting the SAS-CSI RS 512 at the transmission start position. After receiving the temporary RS 511, the terminal is required to complete the AGC setting and T/F tracking before determining the start position for receiving the SAS-CSI RS 512, that is, a reception start position. The reception start position is behind a position for the AGC setting and T/F tracking. The terminal starts receiving the SAS-CSI RS 512 in the case that the network side device and the terminal have consistent understanding of the time domain resource range. In this case, the time domain resource range of the SAS-CSI RS 512 determined by the network side device may be different from the time domain resource range of the SAS-CSI RS 512 determined by the terminal.

In an example, the means of determining the time domain resource range include determining according to the indication information from the network side device. The time domain resource range of a secondary cell activation specific channel state information reference signal (SAS-CSI RS) is determined includes: the start position of the time domain resource range is determined according to an absolute time position indicated by the indication information.

The network side device may indicate that the absolute time position is taken as the start position of the time domain resource range through the indication information in a case that the network side device instructs the terminal to determine the time domain resource range through the indication information.

In an example, the means of determining the time domain resource range include determining according to the indication information from the network side device. The time domain resource range of a secondary cell activation specific channel state information reference signal (SAS-CSI RS) is determined includes: the start position of the time domain resource range is determined according to an offset relative to a preset time domain position and indicated by the indication information.

The network side device may indicate the offset to the terminal, and the terminal may determine the start position of the time domain resource range according to the preset time domain position and the offset indicated by the network side device in a case that the network side device instructs the terminal to determine the time domain resource range through the indication information.

The preset time domain position may be determined based on the protocol or preindicated by the network side device. In an example, the preset time domain position includes at least one of:
a time domain position for receiving the temporary RS;
a time domain position for receiving the indication information; or
a downlink slot corresponding to a time domain position for transmitting a hybrid automatic repeat request (HARQ) corresponding to the indication information.

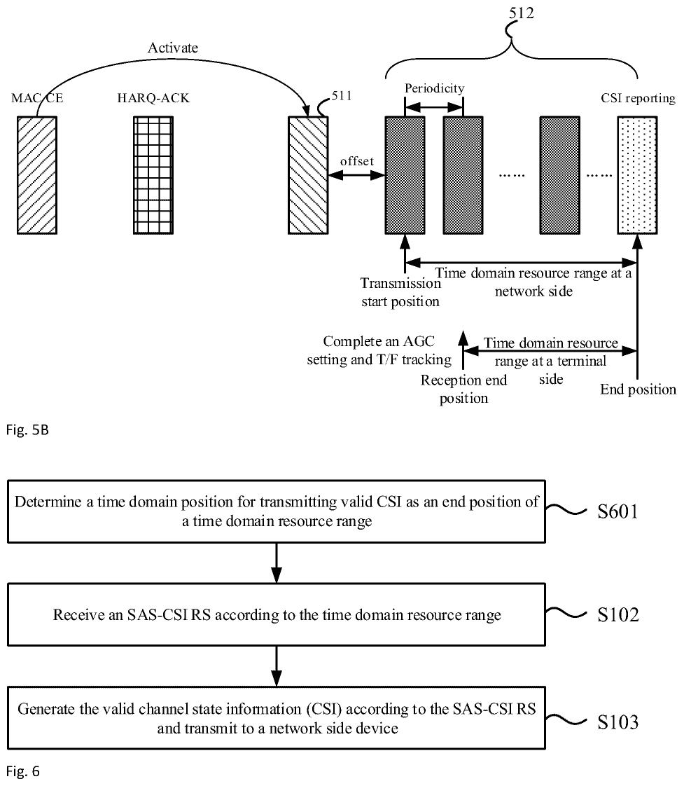

FIG. 6 is a schematic flowchart of yet another method for transmitting channel state information shown according to an example of the disclosure. As shown in 6, the time domain resource range of a secondary cell activation specific channel state information reference signal (SAS-CSI RS) is determined includes:

S601, a time domain position for transmitting the valid CSI is determined as an end position of the time domain resource range.

In an example, the terminal has completed an activation/deactivation process of the secondary cell after transmitting the valid CSI, and thus receives no SAS-CSI RS after transmitting the valid CSI (before the secondary cell is required to be activated/deactivated next time). Thus, the time domain position (for example, a slot) for transmitting the valid CSI may be determined as the end position of the time domain resource range for receiving the SAS-CSI RS. After the end position, the terminal stops receiving the SAS-CSI RS.

Correspondingly, the network side device may determine the time domain position for receiving the valid CSI as the end position of the time domain resource range for transmitting the SAS-CSI RS. After the end position, the network side device stops transmitting the SAS-CSI RS.

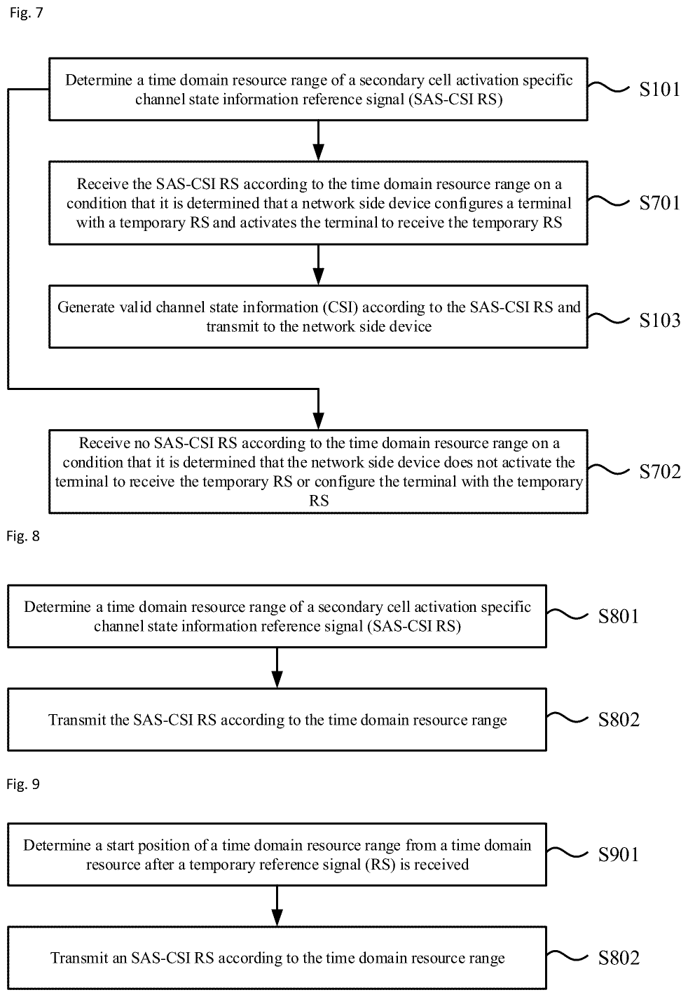

FIG. 7 is a schematic flowchart of another method for transmitting channel state information, as shown in an example of disclosure. As shown in FIG. 7, the SAS-CSI RS is received according to the time domain resource range includes:

S701, the SAS-CSI RS is received according to the time domain resource range on a condition that it is determined that the network side device configures the terminal with a temporary RS and activates the terminal to receive the temporary RS.

In an example, the method further includes:

S702, no SAS-CSI RS is received according to the time domain resource range on a condition that it is determined that the network side device does not activate the terminal to receive a temporary RS or configure the terminal with the temporary RS.

In an example, the valid CSI is determined to be reported as soon as possible in a case that the network side device configures the terminal with the temporary RS and activates the terminal to receive the temporary RS.

Thus, the terminal may receive the SAS-CSI RS according to the time domain resource range on a condition that it is determined that the network side device configures the terminal with the temporary RS and activates the terminal to receive the temporary RS, and receive no SAS-CSI RS according to the time domain resource range on a condition that it is determined that the network side device does not activate the terminal to receive the temporary RS or configure the terminal with the temporary RS.

Correspondingly, the network side device may transmit the SAS-CSI RS according to the time domain resource range on a condition that it is determined that the terminal is configured with the temporary RS and activated to receive the temporary RS, and transmit no SAS-CSI RS according to the time domain resource range on a condition that it is determined that the terminal is not activated to receive the temporary RS or configured with the temporary RS.

Accordingly, the resource waste caused when the terminal receives the SAS-CSI RS and the network side transmits the SAS-CSI RS in a case that no valid CSI is required to be reported as soon as possible can be avoided.

In an example, the method further includes: at least one of the following operations is performed based on the SAS-CSI RS:
the SAS-CSI RS is taken as a quasi-co-location (QCL) source of other RSs before a preset RS is received;
interference measurement is performed according to the SAS-CSI RS; or
mobility management is performed according to the SAS-CSI RS.

In an example, the SAS-CSI RS in the example shown in the disclosure may be different from the P-CSI-RS in the related art. In an aspect, the SAS-CSI RS is transmitted and received only within the time domain resource range, while the P-CSI-RS is transmitted continuously. In another aspect, the periodicity of the SAS-CSI RS may be shorter than the periodicity of the P-CSI-RS, so that the terminal may receive the SAS-CSI RS more rapidly and generate the valid CSI to complete reporting accordingly.

The terminal generally receives the SAS-CSI RS more rapidly in a case that the periodicity of the SAS-CSI RS is shorter than that of the P-CSI-RS. For other RSs before the preset RS, for example, other RSs before the P-CSI-RS, the QCL source of other RSs may be determined more rapidly by taking the SAS-CSI RS as the QCL source of other RSs.

For example, other RSs may include a demodulation reference signal (DMRS), The DMRS is a DMRS in W slots after the terminal activates the secondary cell, where W is an integer greater than or equal to 1 and may be set as required. For example, no P-CSI-RS is received within W slots after the terminal activates the secondary cell.

In addition, other functions may also be implemented based on the SAS-CSI RS. For example, the interference measurement is performed according to the SAS-CSI RS, and the mobility management is performed according to the SAS-CSI RS (for example, whether cell handover is required is determined according to a reception quality of the SAS-CSI RS), which may be specifically expanded as required and will not be limited in the disclosure.

FIG. 8 is a schematic flowchart of a method for transmitting a reference signal shown according to an example of the disclosure. The method for transmitting a reference signal shown in the example may be performed by the network side device. The terminal may communicate with the network side device. The network side device includes, but is not limited to, a network side device in a 4G communication system, a 5G communication system, a 6G communication system, etc., and may be, for example, a base station or core network. The terminal includes, but is not limited to, a mobile phone, a tablet computer, a wearable device, a sensor, an Internet of Things device, etc.

As shown in FIG. 8, the method for transmitting a reference signal may include:

S801, a time domain resource range of a secondary cell activation specific channel state information reference signal (SAS-CSI RS) is determined; and

S802, the SAS-CSI RS is transmitted according to the time domain resource range.

In an example, the network side device may transmit (via broadcast, unicast, or groupcast) the secondary cell activation specific channel state information reference signal, which may be fully referred to as Scell activation specific CSI RS and is referred to as SAS-CSI RS below for the convenience of description.

The network side device and the terminal may determine the time domain resource range (for example, a time window) of the SAS-CSI RS separately. The network side device may transmit the SAS-CSI RS within the time domain resource range determined or transmit the SAS-CSI RS within the time domain resource range determined according to configuration information configured for the terminal.

The configuration information may include periodicity, a number of periodicity (which may be interpreted as a number of transmission), etc. of the SAS-CSI RS. For example, the periodicity involves N slots, where N is smaller than a periodicity threshold M, and M may be set as required. For example, M=10. Generally, a minimum value of N is 4, and the terminal may receive the SAS-CSI RS as soon as possible by appropriately setting the value of N to be small.

The terminal may receive the SAS-CSI RS within the time domain resource range determined. For example, the SAS-CSI RS is transmitted within the time domain resource range determined according to the configuration information configured by the network side device. After receiving the SAS-CSI RS, the terminal may generate valid CSI according to the SAS-CSI RS and transmit the valid CSI to the network side device. The network side device may determine whether the SCell is activated according to the valid CSI.

According to the example of the disclosure, the network side device transmits the secondary cell activation specific channel state information reference signal (SAS-CSI RS) only within the time domain resource range instead of continuously transmitting the SAS-CSI RS. Correspondingly, the terminal is required to receive the SAS-CSI RS only within the time domain resource range.

Accordingly, even if periodicity of the SAS-CSI RS is set to be short, since the network side device transmits the SAS-CSI RS only within the time domain resource range and transmits no SAS-CSI RS outside the time domain resource range, the impact on overhead of the network side device is small. Correspondingly, the terminal receives the SAS-CSI RS only within the time domain resource range and receives no SAS-CSI RS outside the time domain resource range. The periodicity of the SAS-CSI RS is shortened without dramatically increasing network overhead, so that the terminal may activate the secondary cell by receiving the SAS-CSI RS and reporting the valid CSI more rapidly.

In an example, the means of determining the time domain resource range include at least one of:
the time domain resource range is set by the network side device; or
the time domain resource range is determined according to the protocol.

In an example, when the time domain resource range of the SAS-CSI RS may be determined according to the protocol, the network side device and the terminal may determine the time domain resource range of the SAS-CSI RS according to the protocol. The network side device may transmit the SAS-CSI RS within the time domain resource range, and the terminal may receive the SAS-CSI RS within the time domain resource range.

In an example, the time domain resource range of the SAS-CSI RS may be set by the network side device as required and transmitted to the terminal through the indication information, in this case, the network side device may autonomously determine the time domain resource range of the SAS-CSI RS and indicate the time domain resource range to the terminal through the indication information. The network side device may transmit the SAS-CSI RS within the time domain resource range, and the terminal may receive the SAS-CSI RS within the time domain resource range.

The indication information may be carried in the MAC CE, and the MAC CE carrying the indication information may be the same as the MAC CE configured to activate the temporary RS. The indication information may also be carried in other MAC CEs.

FIG. 9 is a schematic flowchart of another method for transmitting a reference signal shown according to an example of the disclosure. As shown in 9, the time domain resource range of a secondary cell activation specific channel state information reference signal (SAS-CSI RS) is determined includes:

S901, a start position of the time domain resource range is determined from a time domain resource after the temporary reference signal (RS) is received.

In an example, the network side device may determine the start position of the time domain resource range from the time domain resources after the temporary RS is transmitted according to the protocol. Correspondingly, the terminal may determine the start position of the time domain resource range from the time domain resource after the temporary RS is received according to the protocol.

For example, the start position may be determined according to a slot in which the temporary RS is positioned and an offset (greater than or equal to 0 slot). For example, the start position is a position obtained after the offset is added to the slot in which the temporary RS is positioned. The offset may be indicated by the network side device or determined according to the protocol.

In an example, the network side device may set the start position of the time domain resource range from the time domain resource after the temporary RS is transmitted as required, transmit the indication information to the terminal, and instruct the terminal to determine the start position of the time domain resource range from the time domain resource after the temporary RS is received through the indication information.

For example, the start position may be determined according to the slot in which the temporary RS is positioned and the offset. For example, the start position is the position obtained after the offset is added to the slot in which the temporary RS is positioned. The offset may be determined according to the protocol or indicated by the network side device.

In an example, since the network side device determines that the valid CSI is required to be reported as soon as possible when configuring the terminal with the temporary RS and activating the terminal to receive the temporary RS, the start position of the time domain resource range may be determined from the time domain resource after the temporary RS is received. Thus, the terminal starts receiving the SAS-CSI RS from the start position when the temporary RS is received and the valid CSI is determined to be reported as soon as possible. Correspondingly, the network side device may start transmitting the SAS-CSI RS after transmitting the temporary RS. The resource waste caused when the terminal receives the SAS-CSI RS and the network side device transmits the SAS-CSI RS in a case that no valid CSI is required to be reported as soon as possible can be avoided.

In an example, the means of determining the time domain resource range include setting by the network side device; and the time domain resource range of a secondary cell activation specific channel state information reference signal (SAS-CSI RS) is determined includes: the start position of the time domain resource range is determined according to an absolute time position set by the network side device.

The network side device may indicate that the absolute time position is taken as the start position of the time domain resource range through the indication information in a case that the network side device instructs the terminal to determine the time domain resource range through the indication information.

In an example, the means of determining the time domain resource range include setting by the network side device; and the time domain resource range of a secondary cell activation specific channel state information reference signal (SAS-CSI RS) is determined includes: the start position of the time domain resource range is determined according to an offset relative to a preset time domain position and set by the network side device.

The network side device may indicate the offset to the terminal, and the terminal may determine the start position of the time domain resource range according to the preset time domain position and the offset indicated by the network side device in the case that the network side device instructs the terminal to determine the time domain resource range through the indication information. The network side device may also determine the start position of the time domain resource range according to the preset time domain position and the offset indicated by the network side device.

The preset time domain position may be determined based on the protocol or preindicated by the network side device. For the network side device and terminal, the offset may be the same, while the preset time domain position may be different.

For example, for the network side device, the preset time domain position includes at least one of:
a time domain position for transmitting the temporary RS;
a time domain position for transmitting the indication information to the terminal, where the indication information is configured to indicate the time domain resource range; or
a downlink slot corresponding to a time domain position for receiving a hybrid automatic repeat request (HARQ) corresponding to the indication information and transmitted by the terminal.

For example, for the terminal, the preset time domain position includes at least one of:
a time domain position for receiving the temporary RS;
a time domain position for receiving the indication information; or
a downlink slot corresponding to a time domain position for transmitting a hybrid automatic repeat request (HARQ) corresponding to the indication information.

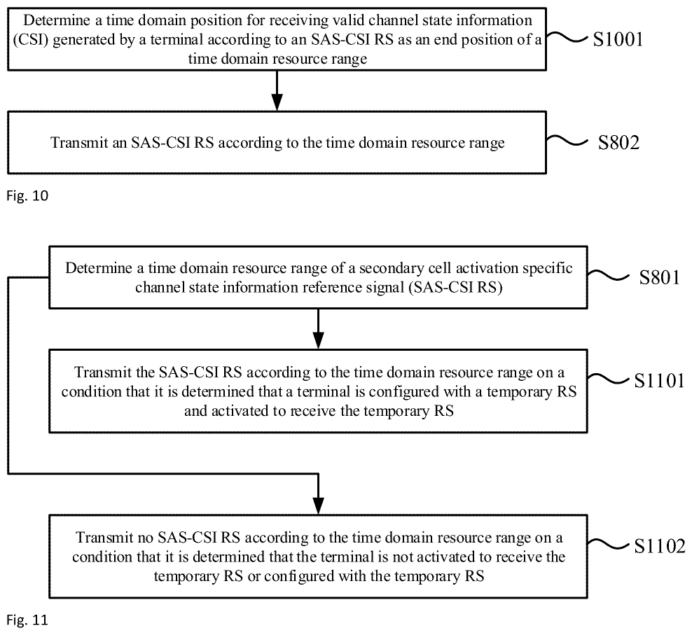

FIG. 10 is a schematic flowchart of yet another method for transmitting a reference signal shown according to an example of the disclosure. As shown in 10, the time domain resource range of a secondary cell activation specific channel state information reference signal (SAS-CSI RS) is determined includes:

S1001, a time domain position for receiving valid channel state information (CSI) generated by the terminal according to the SAS-CSI RS is determined as an end position of the time domain resource range.

In an example, the terminal has completed an activation/deactivation process of the secondary cell after transmitting the valid CSI, and thus receives no SAS-CSI RS after transmitting the valid CSI (before the secondary cell is required to be activated/deactivated next time). Thus, the time domain position (for example, a slot) for transmitting the valid CSI may be determined as the end position of the time domain resource range for receiving the SAS-CSI RS. After the end position, the terminal stops receiving the SAS-CSI RS.

Correspondingly, the network side device may determine the time domain position for receiving the valid CSI as the end position of the time domain resource range for transmitting the SAS-CSI RS. After the end position, the network side device stops transmitting the SAS-CSI RS.

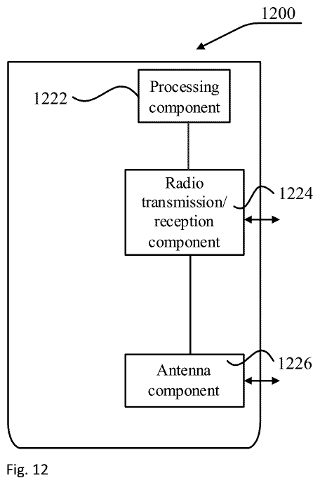

FIG. 11 is a schematic flowchart of still another method for transmitting a reference signal shown according to an example of the disclosure. As shown in FIG. 11, the SAS-CSI RS is transmitted according to the time domain resource range includes:

S1101, the SAS-CSI RS is transmitted according to the time domain resource range on a condition that it is determined that the terminal is configured with the temporary RS and activated to receive the temporary RS.

In an example, the method further includes:

S1102, no SAS-CSI RS is transmitted according to the time domain resource range on a condition that it is determined that the terminal is not activated to receive the temporary RS or configured with the temporary RS.

In an example, the valid CSI is determined to be reported as soon as possible in a case that the network side device configures the terminal with the temporary RS and activates the terminal to receive the temporary RS.

Thus, the terminal may receive the SAS-CSI RS according to the time domain resource range on a condition that it is determined that the network side device configures the terminal with the temporary RS and activates the terminal to receive the temporary RS, and receive no SAS-CSI RS according to the time domain resource range on a condition that it is determined that the network side device does not activate the terminal to receive the temporary RS or configure the terminal with the temporary RS.

Correspondingly, the network side device may transmit the SAS-CSI RS according to the time domain resource range on a condition that it is determined that the terminal is configured with the temporary RS and activated to receive the temporary RS, and transmit no SAS-CSI RS according to the time domain resource range on a condition that it is determined that the terminal is not activated to receive the temporary RS or configured with the temporary RS.

Accordingly, the resource waste caused when the terminal receives the SAS-CSI RS and the network side transmits the SAS-CSI RS in a case that no valid CSI is required to be reported as soon as possible can be avoided.

In an example, the method further includes: other CSI-RSs related to activation of the secondary cell stop being transmitted in a case that the SAS-CSI RS is transmitted according to the time domain resource range.

Since the network side device transmits the SAS-CSI RS within the time domain resource range, the terminal may obtain the valid CSI according to the SAS-CSI RS for reporting. Accordingly, it is not required to generate the valid CSI according to other CSI-RSs related to the activation of the secondary cell, and the network side device may stop (for example, within the time domain resource range) transmitting other CSI-RSs (for example, the P-CSI-RS in the related art) related to the activation of the secondary cell, avoiding wasting a network resource.

Corresponding to the example of the foregoing method for transmitting channel state information and the example of the foregoing method for transmitting a reference signal, an example of an apparatus for transmitting channel state information and an example of an apparatus for transmitting a reference signal are further provided by the disclosure.

An apparatus for transmitting channel state information is provided in the disclosure example. The apparatus for transmitting channel state information may be applicable to the terminal. The terminal includes, but is not limited to, a mobile phone, a tablet computer, a wearable device, a sensor, an Internet of Things device, etc. The terminal may communicate with the network side device. The network side device includes, but is not limited to, a network side device in a 4G communication system, a 5G communication system, a 6G communication system, etc., and may be, for example, a base station or a core network.

In an example, the apparatus for transmitting channel state information includes one or more processors; where the processor is configured to: determine a time domain resource range of a secondary cell activation specific channel state information reference signal (SAS-CSI RS); receive the SAS-CSI RS according to the time domain resource range; and generate valid channel state information (CSI) according to the SAS-CSI RS and transmit the valid CSI to a network side device.

In an example, the means of determining the time domain resource range include at least one of:
the time domain resource range is determined according to indication information transmitted by the network side device; or
the time domain resource range is determined according to the protocol.

In an example, the processor is configured to: determine a start position of the time domain resource range from a time domain resource after a temporary reference signal (RS) is received.

In an example, the processor is configured to: determine a start position of the time domain resource range from a time domain resource after an automatic gain control (AGC) setting and time-frequency (T/F) tracking are completed.

In an example, the means of determining the time domain resource range include determining according to indication information from the network side device. The processor is configured to: determine the start position of the time domain resource range according to an absolute time position indicated by the indication information.

In an example, the means of determining the time domain resource range include determining according to the indication information from the network side device. The processor is configured to: determine the start position of the time domain resource range according to an offset relative to a preset time domain position and indicated by the indication information.

In an example, the preset time domain position includes at least one of:
a time domain position for receiving the temporary RS;
a time domain position for receiving the indication information; or
a downlink slot corresponding to a time domain position for transmitting a hybrid automatic repeat request (HARQ) corresponding to the indication information.

In an example, the processor is configured to: determine a time domain position for transmitting the valid CSI as an end position of the time domain resource range.

In an example, the processor is configured to: receive the SAS-CSI RS according to the time domain resource range on a condition that it is determined that the network side device configures the terminal with a temporary RS and activates the terminal to receive the temporary RS.

In an example, the processor is further configured to: receive no SAS-CSI RS according to the time domain resource range on a condition that it is determined that the network side device does not activate the terminal to receive the temporary RS or configure the terminal with the temporary RS.

In an example, the processor is further configured to:
perform at least one of the following operations based on the SAS-CSI RS:
the SAS-CSI RS is taken as a quasi-co-location (QCL) source of other RSs before a preset RS is received;
interference measurement is performed according to the SAS-CSI RS; or
mobility management is performed according to the SAS-CSI RS.

An apparatus for transmitting a reference signal is provided in the example of the disclosure. The apparatus for transmitting a reference signal may be applicable to the network side device. The terminal may communicate with the network side device. The network side device includes, but is not limited to, a network side device in a 4G communication system, a 5G communication system, a 6G communication system, etc., and may be, for example, a base station or core network. The network side device may communicate with the terminal. The terminal includes, but is not limited to, a mobile phone, a tablet computer, a wearable device, a sensor, an Internet of Things device, etc.

In an example, the apparatus for transmitting a reference signal includes one or more processors; where the processor is configured to: determine a time domain resource range of a secondary cell activation specific channel state information reference signal (SAS-CSI RS); and transmit the SAS-CSI RS according to the time domain resource range.

In an example, the means of determining the time domain resource range include at least one of:
the time domain resource range is set by the network side device; or
the time domain resource range is determined according to the protocol.

In an example, the processor is configured to: determine a start position of the time domain resource range from a time domain resource after a temporary reference signal (RS) is received.

In an example, the means of determining the time domain resource range include setting by the network side device. The processor is configured to: determine a start position of the time domain resource range according to an absolute time position set by the network side device.

In an example, the means of determining the time domain resource range include setting by the network side device. The processor is configured to: determine a start position of the time domain resource range according to an offset relative to a preset time domain position and set by the network side device.

In an example, the preset time domain position includes at least one of:
a time domain position for transmitting the temporary RS;
a time domain position for transmitting the indication information to the terminal, where the indication information is configured to indicate the time domain resource range; or
a downlink slot corresponding to a time domain position for receiving a hybrid automatic repeat request (HARQ) corresponding to the indication information and transmitted by the terminal.

In an example, the processor is configured to: determine a time domain position for receiving valid channel state information (CSI) generated by the terminal according to the SAS-CSI RS as an end position of the time domain resource range.

In an example, the processor is configured to: transmit the SAS-CSI RS according to the time domain resource range on a condition that it is determined that the terminal is configured with the temporary RS and activated to receive the temporary RS.

In an example, the processor is further configured to: transmit no SAS-CSI RS according to the time domain resource range on a condition that it is determined that the terminal is not activated to receive the temporary RS or configured with the temporary RS.

In an example, the processor is further configured to: stop transmitting other CSI-RSs related to activation of the secondary cell in a case that the SAS-CSI RS is transmitted according to the time domain resource range.

A specific way of each module of the apparatus in the above example to perform an operation has been described in detail in the example of the relevant method and will not be repeated here.

Since the apparatus example basically corresponds to the method example, reference may be made to the description of the method example for the relevant parts. The apparatus example described above is merely illustrative. The modules described as separate components may or may not be physically separated. The components shown as modules may be physical modules or not. In other words, the components may be positioned in one place or distributed over a plurality of network modules. The solution in the example may be implemented by selecting some or all the modules as required in practice. Those of ordinary skill in the art can understand and implement the disclosure without creative efforts.

A communication apparatus is further provided in the example of the disclosure. The communication apparatus includes: a processor; and a memory configured to store a computer program; where when the computer program is executed by the processor, the method for transmitting channel state information in any example described above is implemented.

A communication apparatus is further provided in the example of the disclosure. The communication apparatus includes: a processor; and a memory configured to store a computer program; where when the computer program is executed by the processor, the method for transmitting a reference signal in any example described above is implemented.

A computer-readable storage medium is further provided in the example of the disclosure. The computer-readable storage medium is configured to store a computer program, where when the computer program is executed by a processor, steps of the method for transmitting channel state information in any example described above are implemented.

A computer-readable storage medium is further provided in the example of the disclosure. The computer-readable storage medium is configured to store a computer program, where the computer program is executed by a processor, steps of the method for transmitting a reference signal in any example described above are implemented.

FIG. 12 is a schematic block diagram of an apparatus 1200 for transmitting a reference signal shown according to an example of the disclosure. As shown in FIG. 12, the apparatus 1200 may be provided as a base station. With reference to FIG. 12, the apparatus 1200 includes a processing component 1222, a radio transmission/reception component 1224, an antenna component 1226, and a signal processing portion specific to a radio interface. The processing component 1222 may further include one or more processors. One processor in the processing component 1222 may be configured to implement the method for transmitting a reference signal in any example described above.

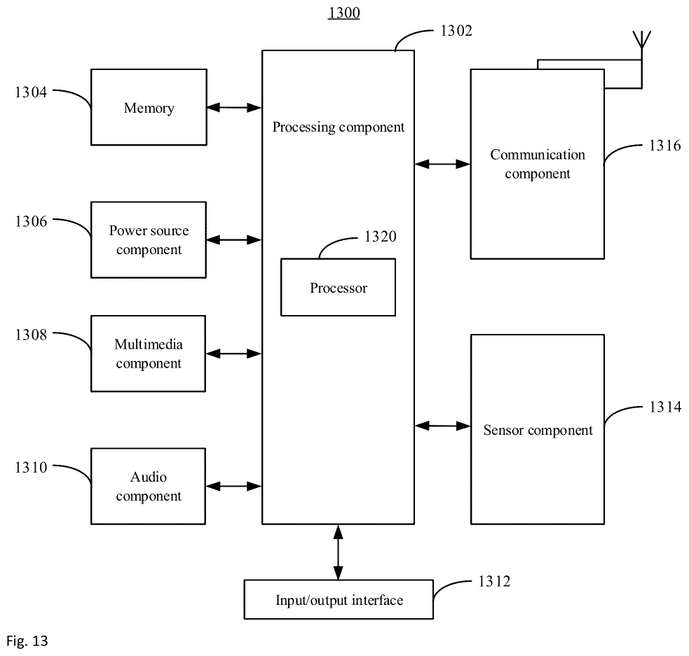

FIG. 13 is a schematic block diagram of an apparatus 1300 for transmitting channel state information shown according to an example of the disclosure. For example, the apparatus 1300 may be a mobile phone, a computer, a digital broadcast terminal, a messaging device, a gaming console, a tablet device, a medical device, a fitness device, a personal digital assistant, etc.

With reference to FIG. 13, the apparatus 1300 may include one or more of the following components: a processing component 1302, a memory 1304, a power source component 1306, a multimedia component 1308, an audio component 1310, an input/output (I/O) interface 1312, a sensor component 1314, and a communication component 1316.

The processing component 1302 generally controls overall operations of the apparatus 1300, for example, operations associated with display, phone calls, data communication, camera operations, and recording operations. The processing component 1302 may include one or more processors 1320 to complete all or some steps of the above method for transmitting channel state information by executing an instruction. In addition, the processing component 1302 may include one or more modules, so as to facilitate interaction between the processing component 1302 and other components. For example, the processing component 1302 may include a multimedia module, so as to facilitate interaction between the multimedia component 1308 and the processing component 1302.

The memory 1304 is configured to support the operation on the apparatus 1300 by storing various types of data. Instances of these data include an instruction configured for any application or method operating on the apparatus 1300, contact data, phone book data, a message, a picture, a video, etc. The memory 1304 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power source component 1306 provides power for various components of the apparatus 1300. The power source component 1306 may include a power source management system, one or more power sources, and other components associated with power generation, management, and distribution for the apparatus 1300.

The multimedia component 1308 includes a screen that provides an output interface between the apparatus 1300 and a user. In some examples, the screen may include a liquid crystal display (LCD) and a touch panel (TP). If including the touch panel, the screen may be implemented as a touch screen, so as to receive an input signal from the user. The touch panel includes one or more touch sensors, so as to sense touches, swipes, and gestures on the touch panel. Except for sensing a boundary of a touch or swipe action, the touch sensor may also measure duration and a pressure associated with a touch or swipe operation. In some examples, the multimedia component 1308 includes a front-facing camera and/or a rear-facing camera. When the apparatus 1300 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capability.

The audio component 1310 is configured to output and/or input audio signals. For example, the audio component 1310 includes a microphone (MIC) configured to receive external audio signals when the apparatus 1300 is in the operation mode, for example, a calling mode, a recording mode, or a speech recognition mode. The audio signals received may be further stored in the memory 1304 or transmitted via the communication component 1316. In some examples, the audio component 1310 further includes a speaker configured to output the audio signal.

The I/O interface 1312 provides an interface between the processing component 1302 and a peripheral interface module. The above peripheral interface module may be a keyboard, a click wheel, a button, etc. These buttons may include, but are not limited to, a home button, a volume button, a start button, and a lock button.

The sensor component 1314 includes one or more sensors configured to provide state assessments for various aspects of the apparatus 1300. For example, the sensor component 1314 may detect an on/off state of the apparatus 1300, and relative positioning of the components. For example, the components are the display and the keypad of the apparatus 1300. The sensor component 1314 may also detect a change in position of the apparatus 1300 or one component of the apparatus 1300, the presence or absence of contact between the user and the apparatus 1300, an orientation or acceleration/deceleration of the apparatus 1300, and a change in temperature of the apparatus 1300. The sensor component 1314 may include a proximity sensor configured to detect the presence of nearby objects in the absence of any physical contact. The sensor component 1314 may further include a light sensor, such as a complementary metal-oxide-semiconductor transistor (CMOS) or charge coupled device (CCD) image sensor configured to be used in imaging application. In some examples, the sensor component 1314 may further include an acceleration sensor, a gyroscope sensor, a magnetic sensor, a pressure sensor, or a temperature sensor.

The communication component 1316 is configured to facilitate wired or radio communication between the apparatus 1300 and other devices. The apparatus 1300 may access a radio network based on a communication standard, such as a wireless fidelity (Wi-Fi) network, a 2nd generation (2G) network, a 3rd generation (3G) network, a 4G long term evolution (LTE) network, a 5G new radio (NR) network, or their combinations. In an illustrative example, the communication component 1316 receives a broadcast signal or broadcast related information from an external broadcast management system via a broadcast channel. In an illustrative example, the communication component 1316 further includes a near field communication (NFC) module, so as to facilitate short-range communication. For example, the NFC module may be implemented on the basis of a radio frequency identification (RFID) technology, an infrared data association (IrDA) technology, an ultra wide band (UWB) technology, a Bluetooth (BT) technology, etc.

In an illustrative example, the apparatus 1300 may be configured to execute the above method for transmitting channel state information by being implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc.

A non-transitory computer-readable storage medium including an instruction, for example, a memory 1304 including an instruction is further provided in an illustrative example. The above-mentioned instruction may complete the above-mentioned method for transmitting channel state information by being executed by a processor 1320 of an apparatus 1300. For example, the non-transitory computer-readable storage medium may be an ROM, a random access memory (RAM), a compact disk read-only memory (CD-ROM), a magnetic tape, a floppy disc, an optical data storage device, etc.

Those skilled in the art will readily conceive of other embodiments of the disclosure after considering the description and practice of the disclosure disclosed here. The disclosure is intended to cover any variations, uses or adaptive changes of the disclosure, which follow the general principles of the disclosure and include common general knowledge or conventional technical means in the art not disclosed in the disclosure. The description and the examples are merely deemed illustrative, and the true scope and spirit of the disclosure are indicated by the following claims.

It should be understood that the disclosure is not limited to precise structures that have been described above and shown in the accompanying drawings, and various modifications and changes can be made without departing from the scope of the disclosure. The scope of the disclosure is limited merely by the appended claims.

It should be noted that the relation terms here such as first and second are merely used to distinguish one entity or operation from another entity or operation without necessarily requiring or implying any such an actual relation or order between these entities or operations. The terms “include,” “encompass,” or any other variations are intended to cover non-exclusive inclusions. Thus, a process, method, article, or device including a series of elements further includes other elements that are not explicitly listed except for those elements, or further includes elements inherent to such a process, method, article, or device. Without more restrictions, the elements defined by the sentence “include a . . . ” do not exclude the existence of other identical elements in the process, method, article, or device including the elements.

The methods and apparatuses according to the examples of the disclosure are described in detail above. The principles and embodiments of the disclosure are set forth by applying specific instances here, and the description of the above examples is merely used to assist in understanding the methods of the disclosure and their core concepts. Moreover, those of ordinary skill in the art will make amendments to the particular embodiments and the application scope according to the concept of the disclosure. In conclusion, the contents of the description should not be interpreted as limiting the disclosure.

1. A method for transmitting channel state information, performed by a terminal, the method comprising:
determining a time domain resource range of a secondary cell activation specific channel state information reference signal (SAS-CSI RS);
receiving the SAS-CSI RS according to the time domain resource range; and
generating valid channel state information (CSI) according to the SAS-CSI RS and transmitting the valid CSI to a network side device.

2. The method according to claim 1, wherein determining the time domain resource range comprise at least one of:
determining the time domain resource range according to indication information transmitted by the network side device; or
determining the time domain resource range according to a protocol.

3. The method according to claim 1, wherein the determining a time domain resource range of a secondary cell activation specific channel state information reference signal (SAS-CSI RS) comprises:
determining a start position of the time domain resource range from a time domain resource after a temporary reference signal (RS) is received.

4. The method according to claim 1, wherein the determining a time domain resource range of a secondary cell activation specific channel state information reference signal (SAS-CSI RS) comprises:
determining a start position of the time domain resource range from a time domain resource after an automatic gain control (AGC) setting and time-frequency (T/F) tracking are completed.

5. The method according to claim 2, wherein determining the time domain resource range comprise determining the time domain resource range according to the indication information from the network side device; and
the determining a time domain resource range of a secondary cell activation specific channel state information reference signal (SAS-CSI RS) comprises:
determining a start position of the time domain resource range according to an absolute time position indicated by the indication information.

6. The method according to claim 2, wherein determining the time domain resource range comprise determining the time domain resource range according to the indication information from the network side device; and the determining a time domain resource range of a secondary cell activation specific channel state information reference signal (SAS-CSI RS) comprises:
determining a start position of the time domain resource range according to an offset relative to a preset time domain position and indicated by the indication information.

7. The method according to claim 6, wherein the preset time domain position comprises at least one of:
a time domain position for receiving a temporary RS;
a time domain position for receiving the indication information; or
a downlink slot corresponding to a time domain position for transmitting a hybrid automatic repeat request (HARQ) corresponding to the indication information.

8. The method according to claim 1, wherein the determining a time domain resource range of a secondary cell activation specific channel state information reference signal (SAS-CSI RS) comprises:
determining a time domain position for transmitting the valid CSI as an end position of the time domain resource range.

9. The method according to claim 1, wherein the receiving the SAS-CSI RS according to the time domain resource range comprises:
receiving the SAS-CSI RS according to the time domain resource range on a condition that it is determined that the network side device configures the terminal with a temporary RS and activates the terminal to receive the temporary RS;
wherein the method further comprising:
receiving no SAS-CSI RS according to the time domain resource range on a condition that it is determined that the network side device does not activate the terminal to receive the temporary RS or configure the terminal with the temporary RS.

10. (canceled)

11. The method according to claim 1, further comprising:
performing at least one of the following operations based on the SAS-CSI RS:
taking the SAS-CSI RS as a quasi-co-location (QCL) source of other RSs before a preset RS is received;
performing interference measurement according to the SAS-CSI RS; or
performing mobility management according to the SAS-CSI RS.

12. A method for transmitting a reference signal, performed by a network side device and comprising:
determining a time domain resource range of a secondary cell activation specific channel state information reference signal (SAS-CSI RS); and
transmitting the SAS-CSI RS according to the time domain resource range.

13. The method according to claim 12, wherein determining the time domain resource range comprise at least one of:
setting the time domain resource range by the network side device; or
determining the time domain resource range according to a protocol.

14. The method according to claim 12, wherein the determining a time domain resource range of a secondary cell activation specific channel state information reference signal (SAS-CSI RS) comprises:
determining a start position of the time domain resource range from a time domain resource after a temporary reference signal (RS) is received.

15. The method according to claim 13, wherein determining the time domain resource range comprise setting the time domain resource range by the network side device; and the determining a time domain resource range of a secondary cell activation specific channel state information reference signal (SAS-CSI RS) comprises:
determining a start position of the time domain resource range according to an absolute time position set by the network side device.

16. The method according to claim 13, wherein determining the time domain resource range comprise setting the time domain resource range by the network side device; and the determining a time domain resource range of a secondary cell activation specific channel state information reference signal (SAS-CSI RS) comprises:
determining a start position of the time domain resource range according to an offset relative to a preset time domain position and set by the network side device.

17. (canceled)

18. The method according to claim 12, wherein the determining a time domain resource range of a secondary cell activation specific channel state information reference signal (SAS-CSI RS) comprises:
determining a time domain position for receiving valid channel state information (CSI) generated by a terminal according to the SAS-CSI RS as an end position of the time domain resource range.

19. The method according to claim 12, wherein the transmitting the SAS-CSI RS according to the time domain resource range comprises:
transmitting the SAS-CSI RS according to the time domain resource range on a condition that it is determined that a terminal is configured with a temporary RS and activated to receive the temporary RS;
wherein the method further comprising:
transmitting no SAS-CSI RS according to the time domain resource range on a condition that it is determined that the terminal is not activated to receive the temporary RS or configured with the temporary RS.

20. (canceled)

21. The method according to claim 12, further comprising:
stopping transmitting other CSI-RSs related to activation of a secondary cell in a case that the SAS-CSI RS is transmitted according to the time domain resource range.

22-23. (canceled)

24. An apparatus for transmitting channel state information, comprising:
one or more processors; and
a memory configured to store a computer program; wherein
when the computer program is executed by the one or more processor, causes the one or more processors are collectively configured to:
determine a time domain resource range of a secondary cell activation specific channel state information reference signal (SAS-CSI RS);
receive the SAS-CSI RS according to the time domain resource range; and
generate valid channel state information (CSI) according to the SAS-CSI RS and transmit the valid CSI to a network side device.

25. An apparatus for transmitting a reference signal, comprising:
one or more processor; and
a memory configured to store a computer program; wherein
when the computer program is executed by the one or more processor, the method for transmitting a reference signal according to claim 12 is implemented.

26-27. (canceled)
